(19) United States
(12) Patent Application Publication
(10) Pub. No.: US 2003/0135674 A1
(43) Pub. Date: Jul. 17, 2003

(54) In-band storage management

(75) Inventors: Robert S. Mason JR., Uxbridge, MA (US); Brian L. Garrett, Hopkinton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: I/O Integrity, Inc., Medway, MA

(21) Appl. No.: 10/319,195

(22) Filed: Dec. 13, 2002

Related U.S. Application Data
(60) Provisional application No. 60/340,360, filed on Dec. 14, 2001.

(51) Int. Cl. G06F 12/00

(52) U.S. Cl. 710/74; 711/113

(57) ABSTRACT

A storage manager platform for a data processing system. The storage manager platform, located within the same housing as a host central processing unit, is connected to receive data from both the processor and a mass storage unit such as a disk drive. The storage manager provides a programming environment that is independent of the host operating system, to permit implementation of storage management functions such as performance, data protection and other functions. Commands destined for the storage manager platform are provided as in-band messages that pass as normal I/O requests, through the disk storage interface, in a manner that is independent of any host system bus in configuration. In certain disclosed embodiments of the invention the application performance enhancement functions can include caching, boot enhancement, Redundant Array of Independent Disk (RAID) processing and the like.

### RELATED APPLICATIONS

This application claims the benefit of U.S. Provisional Application No. 60/340,360, filed on Dec. 14, 2001. The entire teachings of the above application are incorporated herein by reference.

### BACKGROUND OF THE INVENTION

To achieve maximum performance levels, modern data processors utilize a hierarchy of memory devices, including on-chip memory and on board cache, for storing both programs and data. Limitations in process technologies currently prohibit placing a sufficient quantity of on-chip memory for most applications. Thus, in order to offer sufficient memory for the operating system(s, application programs, and user data, computers often use various forms of popular off-processor high speed memory including Static Random Access Memory (SRAM), Synchronous Dynamic Random Access Memory (SDRAM), Synchronous Burst Static Ram (SBSRAM) and the like.

Due to the prohibitive cost of the high-speed random access memory, coupled with their power volatility, a third lower level of the hierarchy exists for non-volatile mass storage devices. Mass storage devices such as a “hard disk” offer increased capacity and fairly s economical data storage. Mass storage devices typically store a copy of the operating system, as well as applications and data. Rapid access to such data is critical to system performance. The data storage and retrieval access performance of mass storage devices, however, are typically much worse than the performance of other elements of a computing system. Indeed, over the last decade, although processor speed has improved by at least a factor of 50, magnetic disk storage speed has only improved by a factor of 5. Consequently, mass storage devices continue to limit the performance of consumer, entertainment, office, workstation, servers and other end applications.

Magnetic disk mass storage devices currently employed in a variety of home, business, and scientific computing applications suffer from significant seek-time access delays along with profound read/write data rate limitations. The fastest available disk drives support only a sustained output data rate in the tens of megabytes per second (MB/sec) data rate. This is in stark contrast to the Personal Computer's (PC) Peripheral Component Interconnect (PCI) bus low end 32 bit/33 Mhz input/output capability of 264 MB/sec and a PC's typical internal local bus capability of 800 MB/sec or more.

Emerging high performance disk interface standards such as Small Computer Systems Interface (SCSI)-3, Fibre Channel, Advanced Technology Attachment (ATA), UltraDMA/66/100, Serial Storage Architecture, and Universal Serial Bus (USB) and USB2 do offer higher data transfer rates; but require intermediate data buffering in random access memory. These interconnect strategies thus do not address the fundamental problem that all modern magnetic disk storage devices for the personal computer marketplace are still limited by their physical media access speed.

One method for improving system performance known in the current art is to decrease the number of disk accesses by keeping frequently referenced blocks of data in memory, or by anticipating the blocks that will soon be accessed and pre-fetching them into memory. The practice of maintaining frequently accessed data in high-speed memory avoiding accesses to slower memory or media is called caching and is a feature of most disk drives and operating systems. Caching is a feature now often implemented in advanced disk controllers.

Performance benefits can be realized with caching due to the predictable nature of disk Input/Output (I/O) workloads. Most I/O's are reads instead of writes typically about 80% and those reads tend to have a high locality of reference. High locality of reference means that reads that happen close to each other in time tend to come from regions of disk that are close to each other in proximity. Another predictable pattern is that reads to sequential blocks of a disk tend to be followed by still further sequential read accesses. This behavior can be recognized and optimized through intelligent pre-fetch techniques. Finally, data written is most likely read in a short period after the time it was written. The afore-mentioned I/O workload profile tendencies make for a cache friendly environment where caching methods can easily increase the likelihood that data will be accessed from high speed cache memory. This helps to avoid unnecessary disk access resulting in a significant performance improvement.

Storage controllers range in size and complexity from a simple PCI based Integrated Device Electronics (IDE) adapter in a PC to a refrigerator-sized cabinet full of circuitry and disk drives. The primary responsibility of such a controller is to manage I/O interface command and data traffic between a host Central Processing Unit (CPU) and disk devices. Advanced controllers typically additionally then add protection through mirroring and advanced disk striping techniques such as Redundant Array of Independent Disks (RAID). Simple low-end controller and high-end, advanced functionality controllers often include memory and caching functionality. For example, caching is almost always implemented in high-end RAID controllers to overcome a performance degradation known as the “RAID-5 write penalty”. But the amount of cache memory available in low-end disk controllers is typically very small and relatively expensive. The target market for such caching controllers is typically the Small Computer System Interconnect (SCSI) or Fibre Channel market which is more costly and out of reach of PC and low-end server users. The cost of caching in advanced high-end controllers is very expensive and is typically beyond the means of entry level PC and server users.

Certain disk drives also add memory to a printed circuit board attached to the drive as a speed-matching buffer. This approach recognizes that data transfers to and from a disk drive are much slower than the I/O interface bus speed that is used for data transfer between the CPU and the drive. The speed matching buffer can help improve transfer rates to and from the rotationally spinning disk medium. However, the amount of such memory that can be placed directly on hard drives is severely limited by space and cost concerns.

Solid State Disk (SSD) is a performance optimization technique implemented in hardware, but is different than hardware based caching. SSD is implemented by creating a device that appears like a disk drive, but is composed instead entirely of solid state memory chips. All read and write accesses to SSD therefore occur at electronic memory speeds, yielding very fast I/O performance. A battery and hard disk storage are typically provided to protect against data loss in the event of a power outage; these are configured “behind” the SSD device to flush its entire contents when power is lost.

The amount of cache memory in a Solid State Disk device is equal in size to the drive capacity available to the user. In contrast, the size of a cache represents only a portion of the device capacity ideally the “hot” data blocks that an application is expected to ask for soon. SSD is therefore very expensive compared to a caching implementation. SSD is typically used in highly specialized environments where a user knows exactly which data may benefit from high-speed memory speed access e.g., a database paging device. Identifying such data sets that would benefit from an SSD implementation and migrating them to an SSD device is difficult and can become obsolete as workloads evolve over time.

Storage caching is sometimes implemented in software to augment operating system and file system level caching. Software caching implementations are very platform and operating system specific. Such software needs to reside at a relatively low level in the operating system or file level hierarchy. However, this in turn means that software cache is a likely source of resource conflicts, crash inducing bugs, and possible source of data corruption. New revisions of operating systems and applications necessitate renewed test and development efforts and possible data reliability bugs. The memory used for caching by such implementations comes at the expense of the operating system and applications that use the very same system memory and operating system resources.

Another method known in the current art is used primarily for protection against disk drive failure, but can also increase system performance, these include methods for simultaneous access of multiple disk drives as data striping and Redundant Array of Independent Disks (RAID). RAID systems afford the user the benefit of protection against a drive failure and increased data bandwidth for data storage and retrieval. By simultaneously accessing two or more disk drives, data bandwidth may be increased at a maximum rate that is linear and directly proportional to the number of disks employed. However, one problem with utilizing RAID systems is that a linear increase in data bandwidth requires a proportional number of added disk storage devices.

Another problem with most mass storage devices is their inherent unreliability. The vast majority of mass storage devices utilize rotating assemblies and other types of electromechanical components that possess failure rates one or more orders of magnitude higher than equivalent solid-state devices. RAID systems use the fact of data redundancy distributed across multiple disks to enhance overall reliability storage system. In the simplest case, data may be explicitly repeated on multiple places on a single disk drive, on multiple places on two or more independent disk drives. More complex techniques are also employed that support various trade-offs between data bandwidth and data reliability.

Standard types of RAID systems currently available include so-called RAID Levels 0, 1, and 5. The configuration selected depends on the goals to be achieved. Data reliability, data validation, data storage/retrieval bandwidth, and cost all play a role in defining the appropriate RAID solution. RAID level 0 entails pure data striping across multiple disk drives. This increases data bandwidth, at best, linearly with the number of disk drives utilized. Data reliability and validation capability are decreased. A failure of a single drive results in a complete loss of data. Thus another problem with RAID systems is that the low cost improvement in bandwidth actually results in a significant decrease in reliability.

RAID Level 1 utilizes disk mirroring where data is duplicated on an independent disk subsystem. Validation of data amongst the two independent drives is possible if the data is simultaneously accessed on both disks and subsequently compared. This tends to decrease data bandwidth from even that of a single comparable disk drive. In systems that offer hot swap capability, the failed drive is removed and a replacement drive is inserted. The data on the failed drive is then copied in the background while the entire system continues to operate in a performance degraded but fully operational mode. Once the data rebuild is complete, normal operation resumes. Hence, another problem with RAID systems is the high cost of increased reliability and associated decrease in performance.

RAID Level 5 employs disk data striping and parity error detection to increase both data bandwidth and reliability simultaneously. A minimum of three disk drives is required for this technique. In the event of a single disk drive failure, that a drive may be rebuilt from parity and other data encoded on remaining disk drives. In systems that offer hot swap capability, the failed drive is removed and a replacement drive is inserted. The data on the failed drive is then rebuilt in the background while the entire system continues to operate in a performance degraded but fully operational mode. Once the data rebuild is complete, normal operation resumes.

### SUMMARY OF THE INVENTION

System level performance degradation of applications running on PCs, workstations and servers due to rising data consumption and a reduced numbers of disk actuators per gigabyte (GB), the risk of data loss due to the unreliability of mechanical disk drives, lowered costs and increased density of memory, and recent advances in embedded processor and I/O controller technology components provide the opportunity and motivation for the subject invention.

A further need is evident for a disk drive controller that can dedicate a relatively smaller amount of memory to dynamically cache only that data which is frequently used. Preferably such a controller would receive commands in line so that control interfaces are as simple as possible. This would allow for both platform and operating system independence to be extended to caching and other high level management functions as well.

Briefly, the present invention is a storage manager platform housed within a data processing system that makes use of a host central processing unit that runs a host operating system and has a system bus for interconnecting other components such as input/output bus adapters. Within the data processing system a disk storage unit is arranged for storing data to be read and written by the host CPU having an interface to the I/O interface bus for so doing.

In accordance with one aspect of the present invention, the storage manager platform located within the same housing as the host central processing unit is connected to receive data from both the processor and the disk storage unit. The storage manager in the preferred embodiment provides a programming environment that is independent of the host operating system to implement storage management function such as performance, data protection and other functions for the disk storage unit. Commands destined for the storage manager platform are provided as in-band messages that pass through the disk storage interface in a manner that is independent of the system bus in configuration.

In certain disclosed embodiments of the invention the application performance enhancement functions can include caching, boot enhancement, Redundant Array of Independent Disk (RAID) processing and the like.

In-band commands are provided as maintenance interface commands that are intermingled within an input/output data stream. These commands may be configured as vendor unique commands that appear to be read commands to the system bus but in fact are used to retrieve configuration, statistics, and error information. Vendor unique write like commands can be used to send configuration change requests to the storage manager.

In other embodiments of the invention the disk storage interface may be standard disk storage interfaces such as an Integrated Device Electronics (IDE), Enhanced IDE (EIDE), Small Computer System Interface (SCSI), any number of Advanced Technology Attachment (ATA) interfaces, Fiber Channel or the like interface. It should be understood that in implementations of the invention the front end bus interface may use a different standard interface specification than that of a back hand interface. For example, the front end disk storage interface may appear to be an SCSI interface to the processor system bus while the back end appearing to be an IDE interface to the storage device itself.

In further preferred embodiments the storage manager uses a software architecture implemented in a multi threaded real time operating system to isolate storage management functions as separate task from front end interface, back end interface, protection and performance acceleration functions.

The storage management device is implemented in the same physical housing as the central processing unit. This may be physically implemented as part of a PCI or other industry standard circuit board format in a custom integrated circuit or as part as a standard disk drive enclosure format.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level block diagram illustrates how the storage management platform is architecturally configured in a host computer system;

FIG. 2 is a high level block diagram of the hardware components of the storage management platform;

FIG. 3 is diagram illustrating how a Peripheral Component Interconnect PCI embodiment of the current invention is connected between the device I/O interface circuitry on a motherboard and a disk storage unit;

FIG. 4 is a diagram illustrating how a disk drive enclosure embodiment of the current invention is connected between the device I/O interface circuitry on a motherboard and a disk storage unit;

FIG. 5 is a diagram illustrating how an application specific integrated circuit embodiment of the current invention is connected between the device I/O interface circuitry on a motherboard and a disk storage unit;

FIG. 6 is a diagram illustrating how a Peripheral Component Interconnect PCI embodiment of the current invention is connected between the device I/O interface circuitry on a host bus adapter and a disk storage unit;

FIG. 7 is a high level block diagram of the software architecture of the storage management platform;

FIG. 8 is a message flow diagram for a read miss;

FIG. 9 is a message flow diagram for a read hit; and

FIG. 10 is a message flow diagram for a write de-stage operation.

### DETAILED DESCRIPTION OF THE INVENTION

A description of preferred embodiments of the invention follows.

The present invention is directed to a storage manager platform which is located within a host computer system connected in a manner which is host processor, system bus and operating system independent providing transparent application performance improvement, protection and/or other management functions for the storage devices connected on the storage bus interface under control of the storage manager platform and located in the same housing as the storage devices and the host central processing unit.

In the following description, it is to be understood that the system elements having equivalent or similar functionality are designated with the same reference numerals in the Figures. It is further understood that the present invention may be implemented in various forms of hardware, software, firmware, or a combination thereof. Preferably the present invention is implemented in application code running over a multi-tasking preemptive Real Time Operating System (RTOS) on a hardware platform comprised of one or more embedded Central Processing Units (CPUs), a Random Access Memory (RAM), and programmable input/output (I/O) interfaces. It is to be appreciated that the various processes and functions described herein may be either part of the hardware, embedded micro-instructions running on the hardware, or application code executed by the RTOS.

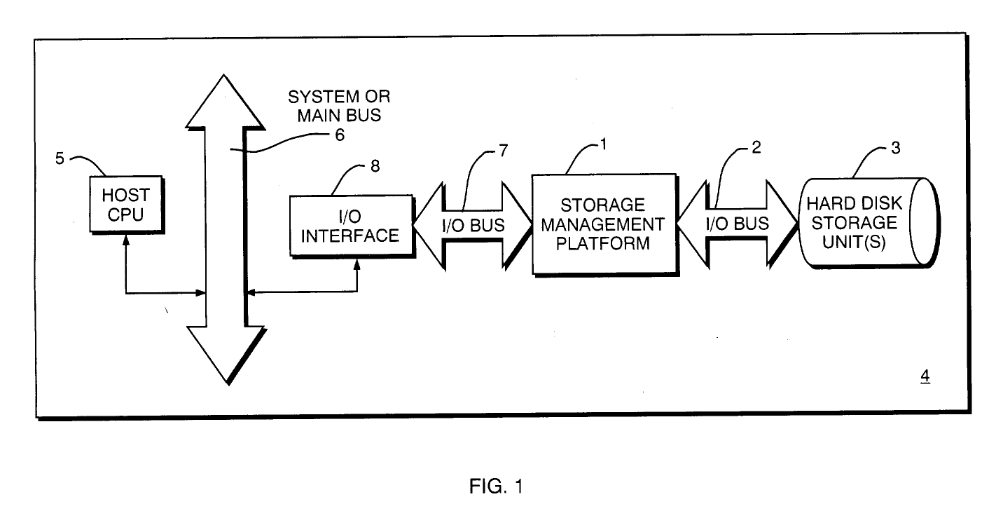

Referring now to FIG. 1, a high level block diagram illustrates how a storage management platform 1 is architecturally configured to be part of a host computer system 4 according to one embodiment of the current invention. The host computer system 4 comprises a host central processing unit 5, a system bus 6, I/O interface circuitry or a host bus adapter, hereafter referred to collectively as I/O interface 8, I/O buses 7 and 2 and a mass storage device 3, such as a disk drive. A typical host computer system may be a Personal Computer (PC) with a Pentium™ class CPU 5 connected by a Peripheral Component Interconnect (PCI) system bus 6 to a chip set on a motherboard containing Advanced Technology Attachment (ATA) (a.k.a. Integrated Device Electronics (IDE)) disk interface circuitry 8. In this instance, the hard disk drive 3 is connected via ATA buses 7 and 2. Note that all of the components of the host computer system 4 described in this diagram, including the storage devices, are contained in the same housing. The storage management platform 1 is a hardware system running storage application software that is configured in-band on the I/O bus interface between the host CPU 7 and the storage device 3. Configured in this manner, the storage management platform 1 appears to the host CPU 4 as a hard disk 3, and to the disk 3 the storage management platform 1 appears as a host CPU 4. It is to be appreciated that this configuration yields completely transparent operation for with the CPU 4 and disk 3.

The system of FIG. 1 generally operates as follows. When an I/O read request for data residing on the hard disk 3 is issued by the host CPU 5 through the I/O interface 8, one or more I/O commands are sent over the I/O buses 7 and 2 towards the hard disk 3. The storage management platform 1 intercepts those I/O requests and executes them, ultimately routing the requested data over the I/O bus 7. The storage management platform 1 executes the I/O requests directly and may emulate those requests avoiding access to the disk 3 entirely through the use of intelligent caching techniques as described below. In this manner, this embodiment provides application performance enhancement through intelligent caching.

According to one embodiment, the I/O interfaces of the storage management platform 7/2 are Advanced Technology Attachment (ATA) (a.k.a. Integrated Device Electronics (IDE)). According to another embodiment, the I/O interfaces are Small Computer System Interface (SCSI). Further, due to the architecture of the embedded software running on the hardware device described below, the subject invention can be implemented independent of the I/O bus interface protocol.

Since the storage management platform is configured on the I/O bus and not the system bus, the preferred embodiment of the subject invention is therefore host CPU 5 independent, operating system independent, and does not require the installation of a storage management platform specific driver.

It is to be understood that although FIG. 1 illustrates a hard disk 3, the storage management platform 1 may be employed with any form of I/O bus attached storage device including all forms of sequential, pseudo-random, and random access storage devices. Storage devices known within the current art include all forms of random access memory, magnetic and optical tape, magnetic and optical disk, along with various forms of solid state mass storage devices.

According to another embodiment, a maintenance console with a Graphical User Interface (GUI) is provided to provide access to performance statistics and graphs, error logs, and configuration data. The user interface software is optionally installed and runs on the host CPU(s).

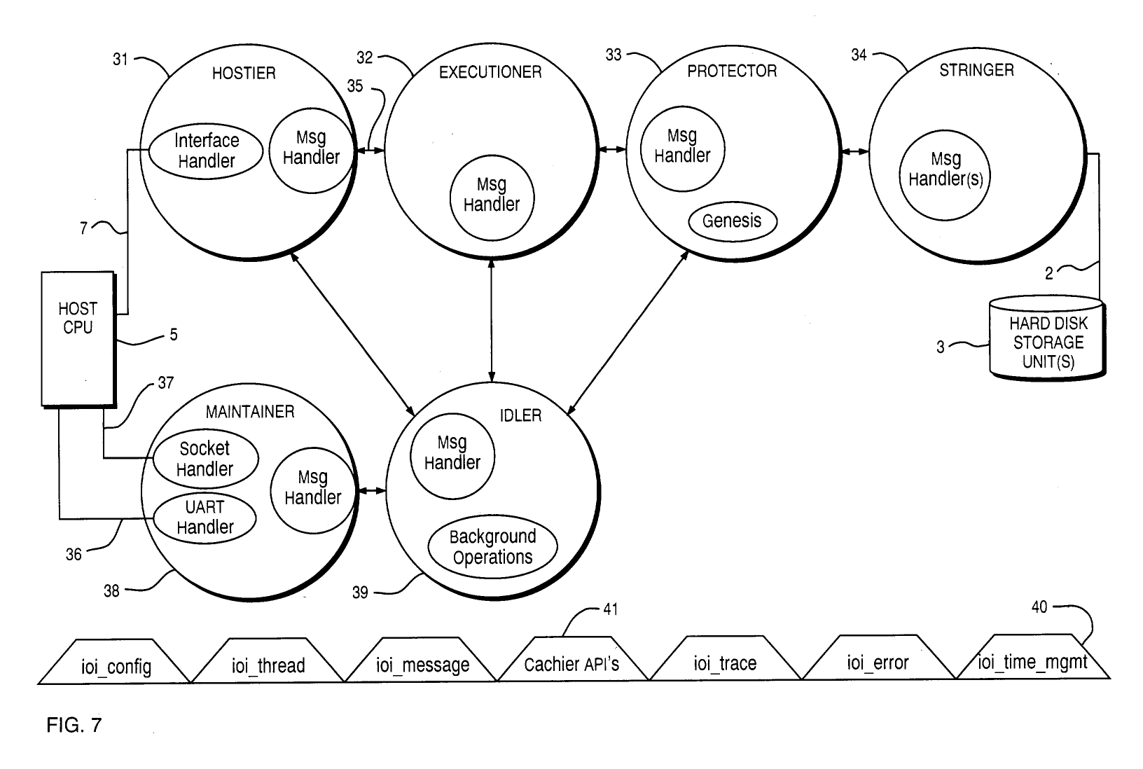

In another embodiment the maintenance interface are sent inter-mingled within the I/O stream over the host I/O interface 7. Such “in-band” maintenance commands are sent through vendor unique commands over the device I/O bus. Vendor unique read-like commands are used to retrieve configuration, statistics, and errors while vendor unique write-like commands are used to send configuration change requests. Referring ahead to FIG. 7, which represents the software architecture of the storage management platform, the Interface Handler thread within the Hostier task 31 processes in-band requests arriving on the host I/O interface 7.

In another embodiment the graphical user interface is implemented in platform independent Java utilizing a Java Native Interface JNI plug-in for optional vendor unique in-band maintenance command protocol support.

In another embodiment of the invention the maintenance commands are sent to the storage management platform over and out-of-band Ethernet interface. Referring ahead to FIG. 7, the Socket Handler thread within the Maintainer task 38 processes these out-of-band requests arriving on the Ethernet interface 37.

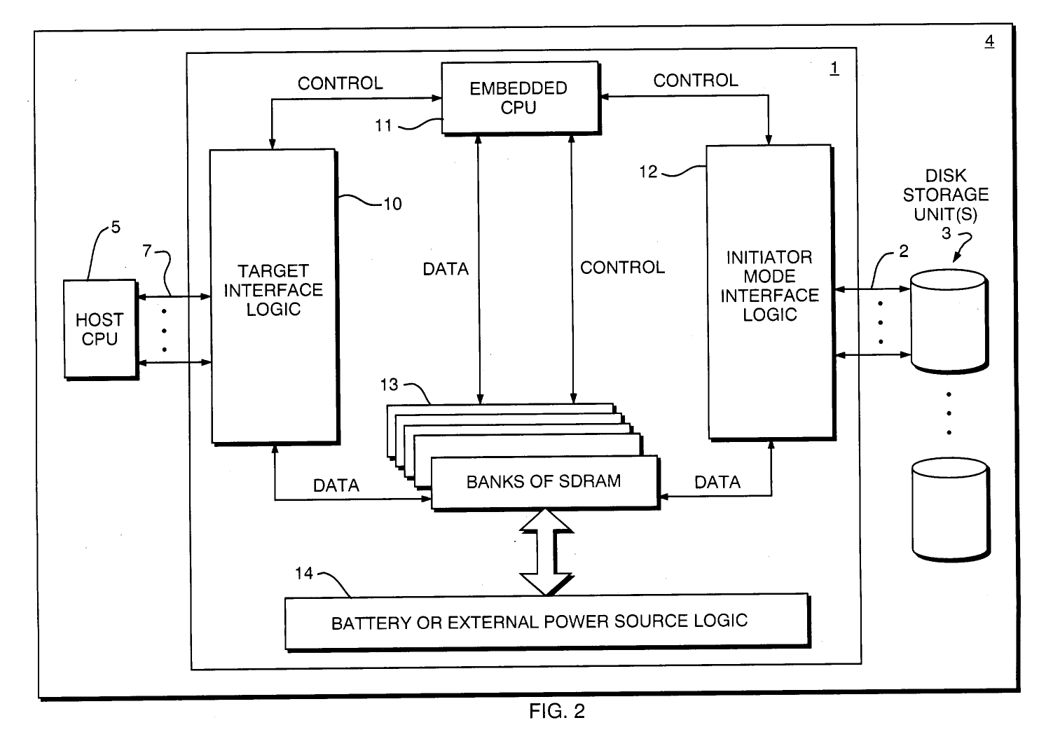

FIG. 2 is a high level block diagram of the hardware components of the storage management platform 1, according to the embodiment. The storage management platform 1 is housed within a computer system comprised of a host CPU 4 connected to a disk storage unit 3 via I/O buses 7 and 2. The storage management platform is comprised of an embedded CPU 11, target mode interface logic 10 which manages I/O bus interface protocol communication with the host I/O interface 8, initiator mode interface logic 12 which manages I/O interface protocol communication with the storage unit 3, banks of Synchronous Dynamic Random Access Memory (SDRAM) 13, for cache and control data and a battery or external power source logic 14 to enable write caching. Direct Memory Access (DMA) Data paths to the and from the host 5 and the disk device 3 are managed via “Control” paths as depicted in the diagram.

The system of FIG. 2 generally operates as follows. A read request arrives at the storage management platform on the host I/O bus 7 and is processed by target Interface logic 10 under the direction of the embedded CPU 11. If the I/O request is a read request for data residing on the disk storage unit 3, then a cache lookup is performed to see if the data resides in the cache memory region in SDRAM 13. If the data is not found in cache a miss, then the embedded CPU 11 builds and sends the read request to the initiator mode logic chip 12 for transmission over the host I/O bus 2 to the disk storage unit 3. Some time later the embedded CPU 11 is notified that the transfer of data from the drive 3 to the cache memory region in SDRAM 13 is complete and the CPU 11 directs the target interface logic 10 to transfer the read data from the cache memory region in SDRAM 13 over the host I/O bus 7 finishing the I/O request. A subsequent read to the same blocks, whereby the read data is found in cache a hit results in a transfer of that data over the host I/O bus 7 avoiding disk 3 access and the involvement of the initiator mode interface logic 12 and the disk storage unit 3.

Write requests arriving on the host I/O bus 7 result in a transfer of write data into the cache memory region of SDRAM 13 by the target Interface logic 10 under the direction of the embedded CPU 11. The write request is reported as complete to the host once the data has been transferred over the host I/O bus 7. Later on, a background task running under the control of the embedded CPU 11 de-stages write requests in the cache region of SDRAM 13 out to the disk storage unit 3 over the device I/O bus 2 using the initiator mode interface logic 12.

Write data residing in the cache region of SDRAM 13 waiting to de-stage to the disk storage unit 3 is protected by a battery or an external power source composed of an Analog Current/Direct Current (AC/DC) converter plugged into a Uninterruptable Power Supply (UPS) 14. In the event that system power is lost the SDRAM 13 thus can be put into a low power mode and the write data may be preserved until power is restored.

In another embodiment the cache region of SDRAM is preserved across host system power outages, to improve the performance during a system boot cycle. As one example, a region of memory 13 is preserved for data blocks accessed during the boot cycle, with those blocks being immediately available during the next boot cycle avoiding relatively slower disk accesses. In another embodiment, the boot data is not preserved, but instead a list of blocks accessed during boot are recorded and fetched from disk during the next power cycle in anticipation of host CPU 5 requests.

It is to be understood that although FIG. 2 illustrates initiator mode logic 12 connected to a single device I/O bus 2 with a single disk storage unit 3, another embodiment of the current invention comprises multiple device I/O bus 2 interfaces (e.g. four back end ATA interfaces). In this configuration, multiple back end device I/O interfaces 2 are under control of initiator mode logic 12 with each device I/O interface 2 connecting to multiple disk storage units 3 (e.g. two ATA hard drives per ATA bus or, for another example, up to 14 SCSI hard drives per SCSI bus).

In another embodiment, multiple host I/O bus interfaces 7 operate under the direction of the target interface logic 10 instead of the single bus depicted 7 (e.g., two front end ATA interfaces).

The front end or host I/O bus 7 and target mode interface logic 10 may support a different I/O bus protocol than that of the back end or device I/O bus 2 and the initiator mode logic 12. Application code residing within the storage management platform 1 running on the embedded CPU 11 manages these differences in bus protocol, addressing and timing. Thus, for example, the host I/O bus may be an ATA/IDE compatible bus and the device I/O bus a SCSI compatible bus; neither the CPU nor the storage unit 3 will be aware of the difference. This permits different standard interface format storage units 3 to be used with hosts that do not necessarily have a compatible I/O bus hardware architecture.

In another embodiment of the current invention illustrating this feature, a single SCSI host device bus 7 is connected to one or more ATA disk storage units 3 over one or more ATA device I/O interfaces 2.

In other embodiments, the storage management platform 1 containing more than one embedded CPU 11.

Another embodiment does not include the battery or external power source 14 thereby eliminating the possibility of safely supporting write caching as described previously.

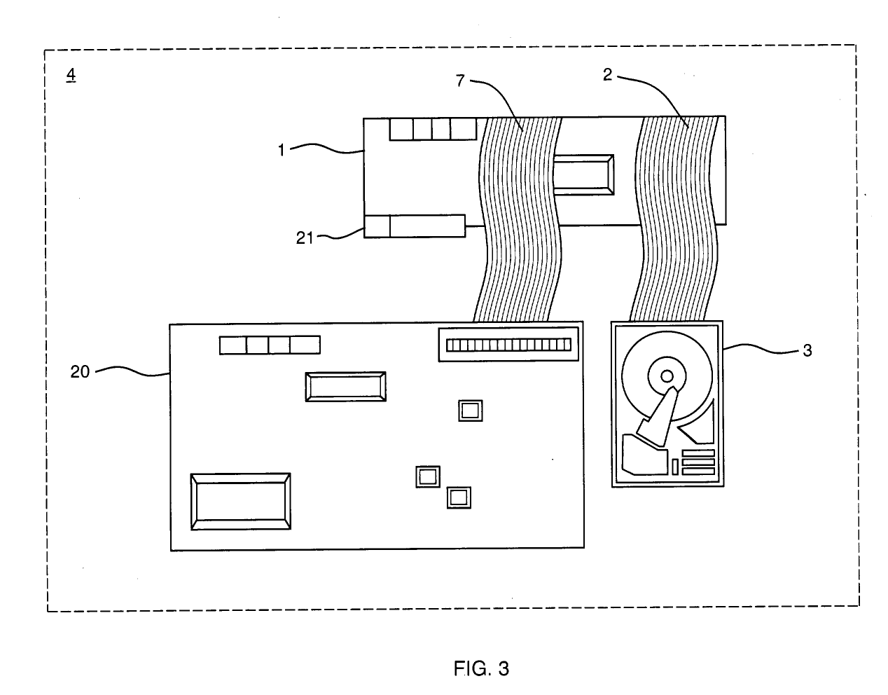

FIG. 3 is a diagram illustrating how a Peripheral Component Interconnect (PCI) or other local bus embodiment of the current invention is connected between the device I/O interface circuitry on a motherboard 20 and a disk storage unit 3 utilizing a host I/O interface 7 cable at the front end of the storage management platform and a device I/O interface 2 cable at the back end. Note that the data flow to and from the motherboard is over the I/O bus through the I/O cable 7. No data is transferred over the PCI bus 21. This embodiment therefore utilizes the PCI slot for placement and power and does not transfer data over the PCI bus. Note that the lack of PCI bus traffic obviates the need for a device driver with specific knowledge of the subject invention yielding transparent configuration and operation.

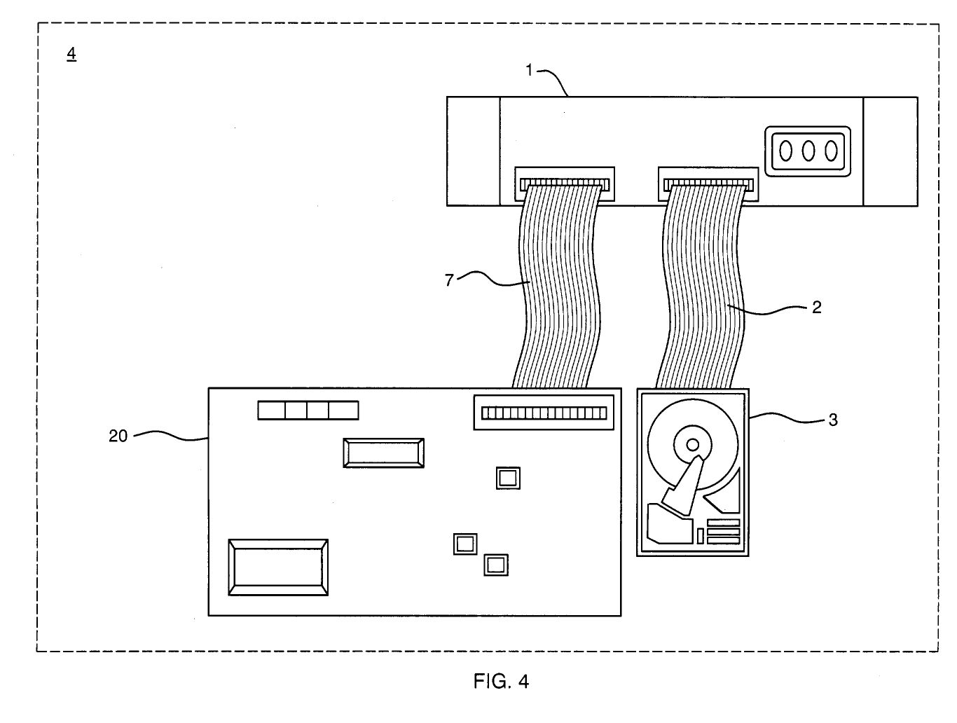

FIG. 4 illustrates how a disk drive enclosure embodiment is connected between the device I/O interface circuitry on a motherboard 20 and a disk storage unit 3 utilizing a host I/O interface 7 cable at the front end of the storage management platform and a device I/O interface 2 cable at the back end. Note that the contents and functionality of the storage management platform as described earlier and illustrated in FIG. 2 are the same in this embodiment; the difference is the packaging for ease of installation by an end user.

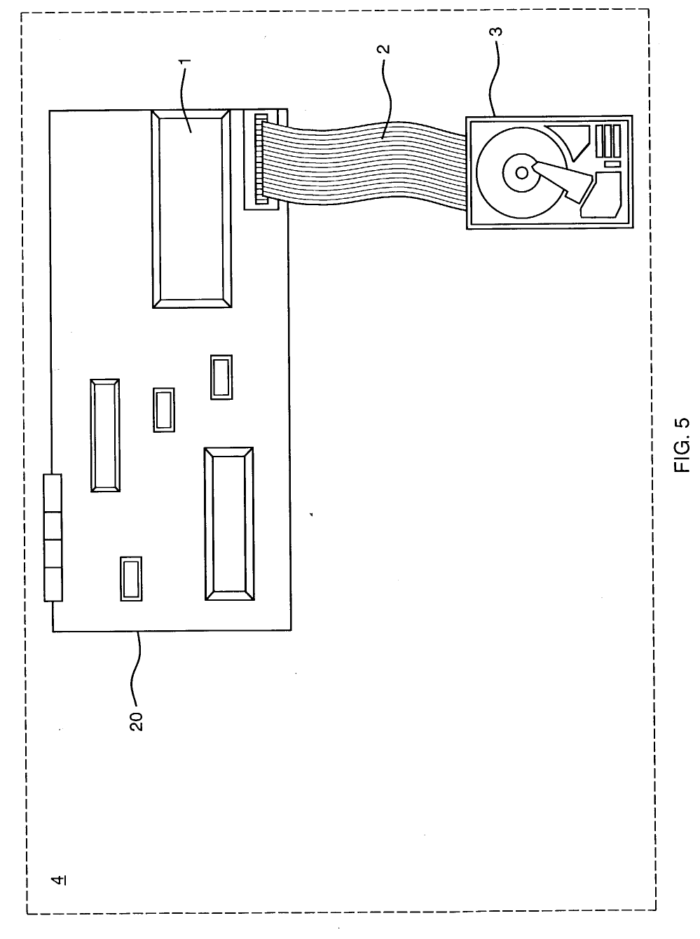

FIG. 5 shows an Application Specific Integrated Circuit (ASIC) embodiment, as connected between the device I/O interface circuitry on a motherboard 20 and a disk storage unit 3 utilizing a device I/O interface 2 cable at the back end. Note that the contents and functionality of the storage management platform as described earlier and illustrated in FIG. 2 are the same in this embodiment; the difference is the packaging, with the form factor being reduced to a single storage management platform chip, and one or more banks of SDRAM.

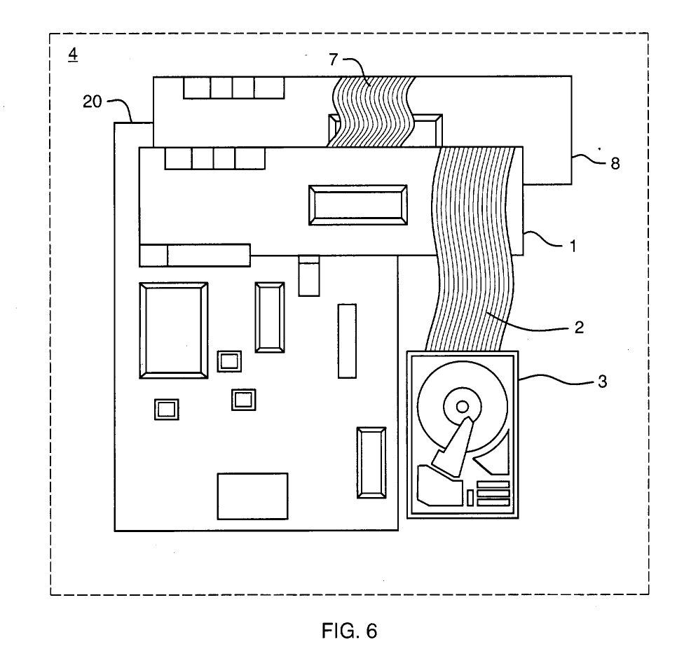

FIG. 6 is a diagram illustrating how a Peripheral Component Interconnect (PCI) embodiment is connected between the device I/O interface circuitry on a host bus adapter 8 and a disk storage unit 3 utilizing a host I/O interface 7 cable at the front end of the storage management platform and a device I/O interface 2 cable at the back end. Note that the data flow to and from the host bus adapter 8 is over the I/O bus through the I/O cable 7. No data is transferred over the PCI bus 21. This embodiment, taken together with the PCI embodiment illustrated in FIG. 3 illustrate how each and every embodiment of the subject invention plugs into the I/O bus and not the system bus, regardless of whether the host end of the I/O bus is implemented as an I/O interface chip on a motherboard or an I/O interface ship on a host bus adapter that plugs into the system bus.

FIG. 7 is a high level block diagram of the software architecture of the storage management platform 1. The host CPU 5 connected via a host I/O interface 7 interfaces with the software architecture at the Hostier task 31, and to a disk storage unit 3 via a device I/O interface 2 at the Stringer Task 34. The software architecture is defined as a set of tasks implemented in a Real Time Operating System (RTOS). The tasks include the Hostier 31, Executioner 32, Protector 33, Stringer 34 Maintainer 38, and Idler 39. Tasks are composed of one or more pre-emptive multi-tasking threads. For example the Hostier task is composed of an interface handling thread 42 and a message handling thread 43. Tasks communicate via clearly defined message queues 35. Common messages are supported by each task, including START_IO and END_IO. Threads within tasks and driver layers abstract hardware interface dependencies from the bulk of the software rendering rapid adaptation to evolving hardware interfaces and standards.

More particularly, the Hostier task 31 is responsible for managing target mode communication with the host I/O interface 7. The Executioner task 32 is a traffic cop with responsibilities including accounting, statistics generation and breaking up large I/O's into manageable chunks. The Protector task 33 is responsible for translating host logical addressable requests to physical device requests, optionally implementing disk redundancy protection through RAID techniques commonly known in the art. The Stringer 34 task is responsible for managing target mode communication with the device I/O interface 2. The Maintainer task 38 is responsible for managing maintenance traffic over serial and Ethernet interfaces. The Idler task 39 is responsible for background operations including write de-stage management. A set of functions with clearly defined application programming interfaces 40 are provided in the architecture for use by any and all tasks and threads including a set of cache memory management functions designated as the Cachier process 41.

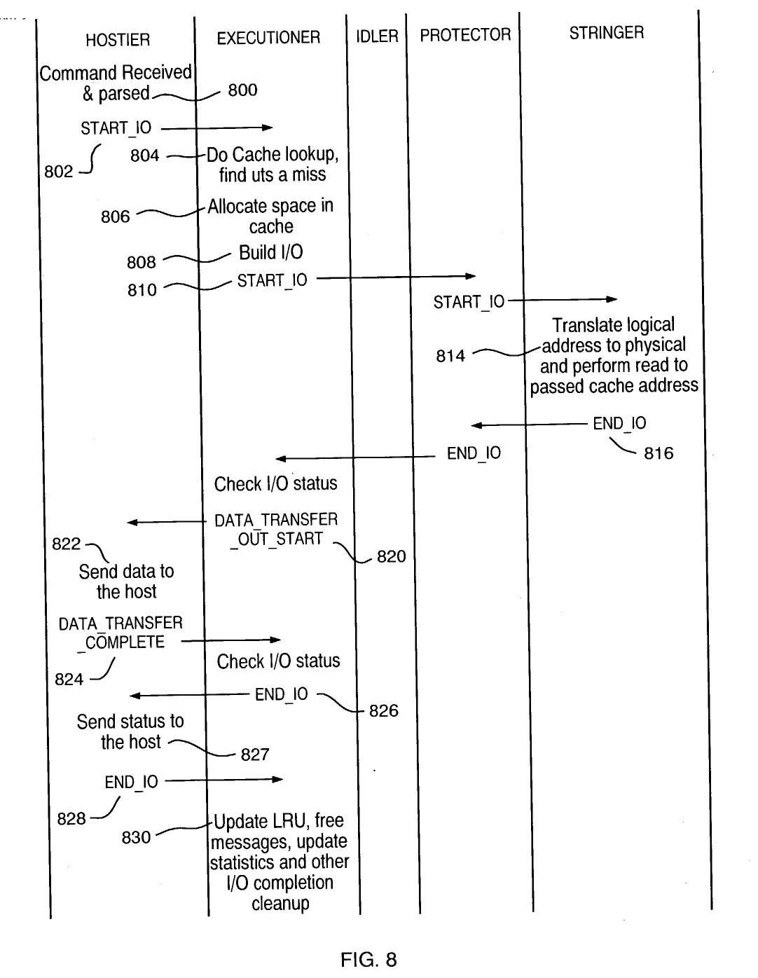

FIG. 8 illustrates a message flow diagram for a read miss with selected tasks of FIG. 7 depicted as column headings and arrows as messages sent between tasks. The read miss begins with command reception 800 by the Hostier task, followed by a START_IO message 802 to the Executioner task. A cache lookup is performed 804. The data is not found, so space in cache is then allocated 806. A START_IO message 808 is built and sent 810 to the Protector task. The Protector task translates the host logical address to one or more drive physical addresses according to the RAID configuration of the group. The Protector task builds and sends one or more START_IO requests 812 to the Stringer task. The Stringer task then sends 814 the read request(s to the disk storage unit(s and waits for ending status. Some time later the Stringer task detects ending status from the storage unit S and builds and sends an END_IO message 816 to the Executioner task. The Executioner task checks the I/O status and if no error is detected sends a DATA_TRANSFER_START message to the Hostier task. The Hostier task then sends the data to the host 822 and sends a DATA_TRASNFER_COMPLETE message 824 to the Executioner task. The Executioner task checks I/O status and sends an END I/O message 826 to the Hostier task. The Hostier task sends status for the lost 827 and returns an END_IO message 828 to the Executioner task. The Executioner task 330 updates cache and message data structures, increments statistics, and cleans up marking the end of a read miss.

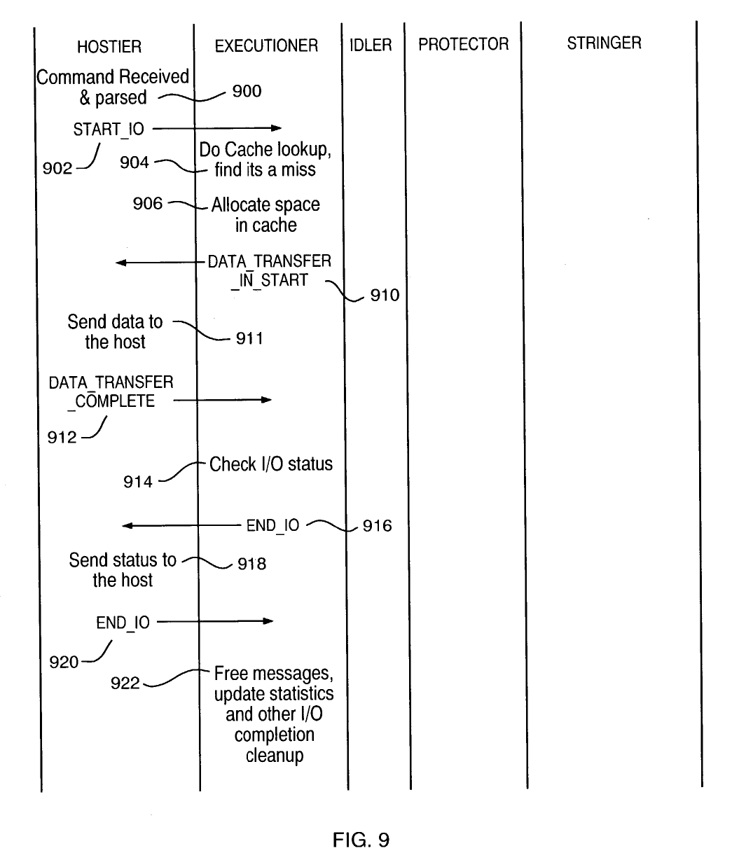

Referring now to FIG. 9, a message flow diagram for a read hit is shown. The I/O begins with command reception 900 by the Hostier task, followed by a START_IO message 902 to the Executioner task. A cache lookup is performed 904, the data is found, and cache space is allocated 906. The Executioner sends a DATA_TRANSFER_START message 910 to the Hostier task. The Hostier task sends the data to the host 911 and sends a DATA_TRASNFER_COMPLETE message 912 to the Executioner task. The Executioner task checks I/O status 914 and sends an END I/O message 912 to the Hostier task. The Hostier task sends status 918 and returns an END_IO message to the Executioner task. The Executioner task 922 updates cache and message data structures, increments statistics, and cleans up marking the end of a read hit.

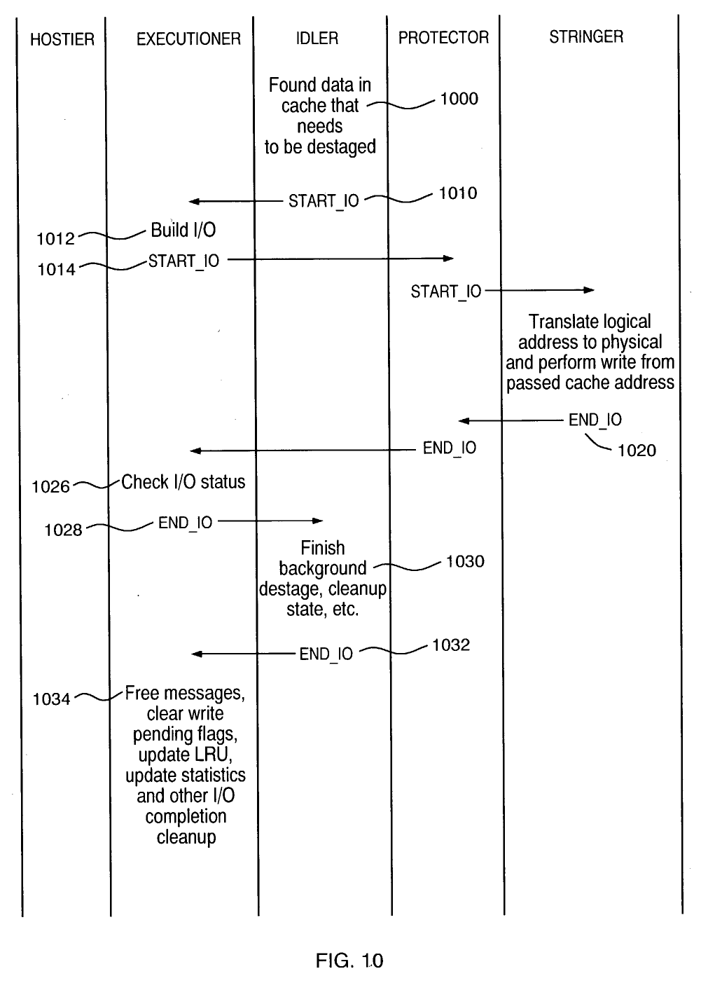

FIG. 10 depicts a message flow diagram for a background write according to another embodiment, with selected tasks of FIG. 7 depicted as column headings and arrows as messages sent between tasks. The I/O begins with the Idler task detecting 1000 write data in cache that needs to be de-staged to disk. The Idler task builds and sends a START_IO task 1010 to the Executioner task which is forwarded to the Protector task. The Protector task translates the host logical address to one or more drive physical addresses according to the RAID configuration of the group. The Protector task 1012 builds and sends one or more START_IO requests 1014 to the Stringer task. The Stringer task write read request(s and write data to the disk storage unit(s and waits for ending status. Some time later the Stringer task detects ending status from the storage unit(s and builds and sends an END_IO message 1020 to the Executioner task. The Executioner task checks I/O status 1026 and sends an END_IO message1028 to the Idler. The Idler 1030 finishes the background write de-stage operation, updates state, cleans up and sends and END_IO message 1032 to the Executioner. The Executioner task 1034 updates cache and message data structures, increments statistics, and cleans up marking the end of a de-stage write operation.

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included with the scope of the invention as defined by the appended claims.

What is claimed is:

1. A data processing system comprising:
a host Central Processing Unit CPU, located within a housing, the host CPU running a host operating system, and the host CPU having a system bus for interconnecting other data processing system components to the host CPU;
an I/O interface for connecting the host system bus to an I/O device bus so that data may be transferred to and from the host CPU;
a storage unit for storing data to be read and written by the host CPU, the storage unit being connected to the I/O interface for receiving data from and providing data to the host CPU; and
a storage manager, the storage manager being located within the same housing as the host processor, the storage manager connected to receive data from both the processor and the disk storage unit, the storage manager providing a programming environment that is independent of the host operating system, and the storage manager providing at least one provided function selected from the group consisting of application performance enhancement, data protection, and other management functions for the disk storage unit, such that the provided function is implemented using in-band management commands that pass through the I/O interface in a manner that is independent of the host system bus configuration.

2. A system as in claim 1 wherein the storage manager is located in an in-band location on the I/O device bus between the I/O interface and the disk storage unit.

3. A system as in claim 1 wherein the provided application performance enhancement function is caching.

4. A system as in claim 1 wherein the provided application performance enhancement function is boot enhancement.

5. A system as in claim 1 wherein a provided data protection function is Redundant Array of Independent Disk (RAID) processing.

6. A system as in claim 1 wherein the storage manager additionally comprises a user interface to provide a user access to performance statistics, error logs, or configuration data.

7. A system as in claim 1 wherein storage manager commands are sent inter-mingled within an I/O stream over the device I/O bus.

8. A system as in claim 7 wherein the storage manager commands comprise data read-like commands used to retrieve configuration, statistics, and error information, and data write-like commands used to send configuration change requests.

9. A system as in claim 1 wherein the disk storage interface is configured as a standard disk storage interface selected from the group consisting of Integrated Device Electronics (IDE), Enhanced IDE (EIDE), Small Computer System Interface (SCSI), Advanced Technology Attachment (ATA), and Fiber Channel.

10. A system as in claim 1 wherein a front end bus interface of the storage manager connected to the host system bus may have a different standard interface specification than that of a back end bus interface connected to the storage unit.

11. A system as in claim 9 wherein the front bus interface is Small Computer System Interface (SCSI) compatible.

12. A system as in claim 9 wherein the back bus interface is Integrated Device Electronics (IDE) compatible.

13. A system as in claim 1 wherein the storage manager uses a software architecture implemented over a multithreaded real time operating system to isolate a front end interface, a back end interface, and management functions as separate tasks.

14. A system as in claim 13 wherein the management functions are selected from a group consisting of protection, performance acceleration, and other storage management functions.

15. A system as in claim 1 wherein the storage manager is provided within a standard disk drive enclosure format.

16. A system as in claim 1 wherein the storage manager is provided in a Peripheral Component Interconnect (PCI) interface board format.

17. A system as in claim 1 wherein the storage manager is provided in an integrated circuit format.
